(19) United States
(12) Patent Application Publication
(10) Pub. No.: US 2026/0074793 A1
(43) Pub. Date: Mar. 12, 2026

(54) TRANSMISSION SYSTEM AND TRANSMISSION METHOD

(71) Applicant: NTT, Inc., Tokyo (JP)

(72) Inventors: Hideki TOSHINAGA, Musashino-shi (JP); Yasuyoshi YAMAMOTO, Musashino-shi (JP); Yuta TAKAHASHI, Musashino-shi (JP); Yushi SHIRATO, Musashino-shi (JP); Takuto ARAI, Musashino-shi (JP); Daisei UCHIDA, Musashino-shi (JP); Naoki KITA, Musashino-shi (JP)

(73) Assignee: NTT, Inc., Tokyo (JP)

(21) Appl. No.: 19/107,146

(22) PCT Filed: Sep. 15, 2022
(86) PCT No.: PCT/JP2022/034577

§ 371 Date: Feb. 27, 2025

(51) Int. Cl. H04B 10/27; H04B 10/112

(52) U.S. Cl. CPC H04B 10/27; H04B 10/1129

(57) ABSTRACT

A transmission system includes one or more first communication apparatuses that transmit and receive a wireless signal to and from a wireless terminal apparatus, one or more second communication apparatuses that transmit and receive an optical signal to and from the first communication apparatus, and one or more transfer apparatuses that transfer an optical signal between the first communication apparatus and the second communication apparatus. The first communication apparatus converts a wireless signal to be transmitted and received to and from the wireless terminal apparatus and an optical signal having a wavelength corresponding to a physical feature amount of a wireless section to be transmitted by the wireless signal. The transfer apparatus receives an optical signal between the first communication apparatus and the second communication apparatus and transfers the received optical signal to the first communication apparatus, the second communication apparatus, or a transfer apparatus that is a transfer destination according to a wavelength of the optical signal. The second communication apparatus transmits and receives to and from the first communication apparatus, an optical signal transferred by the one or more transfer apparatuses and having the wavelength corresponding to a wireless section to be processed by an own apparatus.

### TECHNICAL FIELD

The present invention relates to a transmission system and a transmission method.

### BACKGROUND ART

As a technique for efficiently accommodating wireless systems, an analog radio-over-fiber (ROF) technique for converting a wireless signal as it is into an optical signal and transmitting the optical signal through an optical fiber has been studied (see, for example, Non Patent Literature 1). For example, in a wireless local area network (LAN), there is a technique of mapping service set identifiers (SSIDs) which are identifiers of wireless sections, and virtual local area networks (VLANs), and constructing a network logically segmented by wireless sections and wired sections (see, for example, Non Patent Literature 2).

### CITATION LIST

### Non Patent Literature

Non Patent Literature 1: Kota Ito, and four others, “Efficiently Accommodating High-frequency-band Wireless Systems by Using Analog Radio-over-fiber”, NIT Technical Journal, March 2020, Internet <URL: https://journal. ntt.co.jp/article/1248>

Non Patent Literature 2: Hiroshi Hojo, “Approach to NTTBP Supporting Wi-Fi Platform of NTT group”, NIT Technical Journal, March 2014, Internet <URL: https://journal.ntt.co.jp/backnumber2/1403/files/jn201 403077.html>

### SUMMARY OF INVENTION

### Technical Problem

The segments constructed by the wireless sections and the wired sections by mapping the SSIDs and the VLANs are logical segments and are not physical segments. For this reason, in a case where there is a layer 2 switch in an intermediate path, there are problems of occurrence of a processing delay in logical layer 2 switching, concern in security compared with physical segments, and the like.

In view of the above circumstances, an object of the present invention is to provide a transmission system and a transmission method capable of reducing a delay of signal transfer while improving security in a network including a wireless section and a wired section.

### Solution to Problem

One aspect of the present invention is a transmission system including: one or more first communication apparatuses that transmit and receive a wireless signal to and from a wireless terminal apparatus; one or more second communication apparatuses that transmit and receive an optical signal to and from the first communication apparatus; and one or more transfer apparatuses that transfer an optical signal between the first communication apparatus and the second communication apparatus, in which the first communication apparatus converts a wireless signal to be transmitted and received to and from a wireless terminal apparatus and an optical signal having a wavelength corresponding to a physical feature amount of a wireless section to be transmitted by the wireless signal to each other, the transfer apparatus receives an optical signal between the first communication apparatus and the second communication apparatus and transfers the received optical signal to the first communication apparatus, the second communication apparatus, or another transfer apparatus that is a transfer destination according to a wavelength of the optical signal, and the second communication apparatus transmits and receives to and from the first communication apparatus, an optical signal transferred by the one or more of transfer apparatuses and having the wavelength corresponding to a wireless section to be processed by an own apparatus.

One aspect of the present invention is a transmission method in a transmission system including: one or more first communication apparatuses that transmit and receive a wireless signal to and from a wireless terminal apparatus; one or more second communication apparatuses that transmit and receive an optical signal to and from the first communication apparatus; and one or more transfer apparatuses that transfer an optical signal between the first communication apparatus and the second communication apparatus, the transmission method including: a step of converting, by the first communication apparatus, a wireless signal to be transmitted and received to and from a wireless terminal apparatus and an optical signal having a wavelength corresponding to a physical feature amount of a wireless section to be transmitted by the wireless signal to each other; a step of receiving, by the transfer apparatus, an optical signal between the first communication apparatus and the second communication apparatus and transferring the received optical signal to the first communication apparatus, the second communication apparatus, or another transfer apparatus that is a transfer destination according to a wavelength of the optical signal; and a step of transmitting and receiving to and from the first communication apparatus, by the second communication apparatus, an optical signal transferred by the one or more of the transfer apparatuses and having the wavelength corresponding to a wireless section to be processed by an own apparatus.

### Advantageous Effects of Invention

According to the present invention, it is possible to reduce a delay of signal transfer while improving security in a network including a wireless section and a wired section.

### BRIEF DESCRIPTION OF DRAWINGS

FIG. 1 A view illustrating a configuration example of a transmission system according to an embodiment of the present invention.

FIG. 2 A view illustrating identifiers of wireless sections according to the embodiment.

FIG. 3 A view illustrating the identifiers of the wireless sections according to the embodiment.

FIG. 4 A functional block diagram of a first wireless base station and a second wireless base station according to the embodiment.

FIG. 5 A view illustrating functions of a gateway according to the embodiment.

FIG. 6 A view illustrating signal transfer in the transmission system according to the embodiment.

### DESCRIPTION OF EMBODIMENTS

Hereinafter, an embodiment of the present invention will be described in detail with reference to the drawings. A transmission system according to the present embodiment associates a wireless signal with an optical signal in a wired section by physical conversion and constructs segments. Thus, there is no signal processing that causes a delay in a case where logical processing is performed, or processing such as switching to be performed by being accumulated in a buffer. This can reduce a processing delay. In addition, the transmission system of the present embodiment can transfer signals without performing logical processing. There is no intermediate device that performs logical processing, and thus, security is improved.

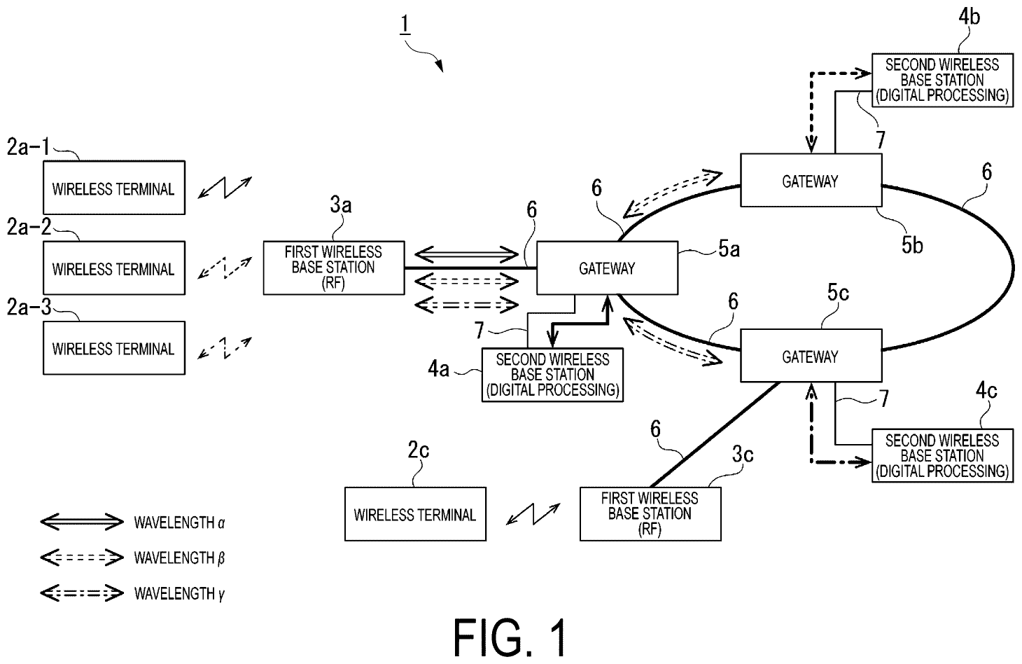

FIG. 1 is a view illustrating a configuration example of a transmission system 1 according to an embodiment of the present invention. The transmission system 1 is an analog radio-over-fiber (RoF) transmission system. The transmission system 1 includes a wireless terminal 2, a first wireless base station 3, a second wireless base station 4, and a gateway 5. For example, the first wireless base station 3 is an extension station, and the second wireless base station 4 is an aggregation station.

The first wireless base station 3 transmits and receives wireless signals to and from the wireless terminal 2. The first wireless base station 3 is connected to the gateway 5 via an optical fiber 6. The first wireless base station 3 has a function of converting a wireless signal of a radio frequency (RF) received from the wireless terminal 2 into an optical signal as an analog signal. The first wireless base station 3 converts the wireless signal received from the wireless terminal 2 into an optical signal having a wavelength corresponding to an identifier of a wireless section to be transmitted by the wireless signal and transmits the converted optical signal to the second wireless base station 4 via the gateway 5. As the identifier of the wireless section, a physical feature amount of the wireless section is used. In addition, the first wireless base station 3 converts an optical signal input from the second wireless base station 4 via the optical fiber 6 into a wireless signal of an analog signal and transmits the converted wireless signal to the wireless terminal 2 through a wireless section of an identifier according to a wavelength of the optical signal.

The second wireless base station 4 is connected to the gateway 5 via an optical transmission line 7. The second wireless base station 4 performs modulation/demodulation processing, access control, and the like, of a wireless signal by digital processing. The second wireless base station 4 that performs processing is determined for each wireless section. The second wireless base station 4 receives the optical signal output from the first wireless base station 3 via one or more gateways 5 and converts the received optical signal into an electrical signal. The second wireless base station 4 demodulates the wireless signal as an electrical signal by digital processing. In addition, the second wireless base station 4 modulates a signal to be transmitted to the wireless terminal 2 by digital processing to generate a wireless signal. The second wireless base station 4 converts the generated wireless signal into an optical signal having a wavelength corresponding to the wireless section to be used by a destination wireless terminal 2 and outputs the converted optical signal to the first wireless base station 3 via the gateway 5.

The gateway 5 receives the optical signal and outputs the optical signal to an output destination according to the wavelength of the received optical signal. Specifically, the gateway 5 receives input of the optical signal output from the first wireless base station 3, selects whether to drop (branch) the input optical signal to the second wireless base station 4 connected to an own apparatus or transfer the input optical signal to another gateway 5 connected via the optical fiber 6 according to the wavelength of the optical signal and performs the selected processing. The gateway 5 receives the optical signal output from the second wireless base station 4, selects whether to transfer the input optical signal to the first wireless base station 3 connected to the own apparatus or to another gateway 5 according to the wavelength of the optical signal and transfers the optical signal to the selected transfer destination.

FIG. 1 illustrates an example in which the first wireless base station 3 transmits and receives an optical signal having a wavelength determined according to an identifier of a wireless section to and from the second wireless base station 4 via the gateway 5. Three gateways 5 connected in a ring shape via the optical fiber 6 are referred to as gateways 5a, 5b, and 5c, respectively. The first wireless base station 3 and the second wireless base station 4 connected to the gateway 5a are referred to as a first wireless base station 3a and a second wireless base station 4a, respectively, the second wireless base station 4 connected to the gateway 5b is referred to as a second wireless base station 4b, and the first wireless base station 3 and the second wireless base station 4 connected to the gateway 5c are referred to as a first wireless base station 3c and a second wireless base station 4c, respectively. The three wireless terminals 2 that wirelessly communicate with the first wireless base station 3a are referred to as wireless terminals 2a-1 to 2a-3, and the wireless terminal 2 that wirelessly communicates with the first wireless base station 3c is referred to as wireless terminal 2c.

The signal transfer in upstream communication in a direction from the wireless terminal 2 to the second wireless base station 4 will be described. The first wireless base station 3a receives an uplink wireless signal and converts the received wireless signal into an optical signal having a wavelength according to an identifier of the wireless section. Alternatively, the first wireless base station 3a selects the second wireless base station 4 on the basis of the identifier of the wireless section and converts the wireless signal into an optical signal having a wavelength according to the selected second wireless base station 4. The first wireless base station 3a converts a wireless signal received from the wireless terminal 2a-1 into an optical signal having a wavelength α, converts a wireless signal received from the wireless terminal 2a-2 into an optical signal having a wavelength β, and converts a wireless signal received from the wireless terminal 2a-3 into an optical signal having a wavelength γ. The first wireless base station 3a outputs the optical signals of the wavelengths α, β, and γ to the optical fiber 6 between the first wireless base station 3a and the gateway 5a.

The gateway 5a receives input of the optical signals of the wavelengths α, β, and γ output from the first wireless base station 3a from the optical fiber 6. The gateway 5a drops the optical signal having the wavelength α to the second wireless base station 4a that is an output destination according to the wavelength α. In addition, the gateway 5a outputs the optical signal having the wavelength β to the optical fiber 6 between the gateway 5a and the gateway 5b that is an output destination according to the wavelength β and outputs the optical signal having the wavelength γ to the optical fiber 6 between the gateway 5a and the gateway 5c that is an output destination according to the wavelength γ.

The second wireless base station 4a converts the optical signal having the wavelength α dropped by the gateway 5a into an electrical signal and performs predetermined digital processing on the wireless signal from the wireless terminal 2a-1 converted into the electrical signal.

The gateway 5b drops the optical signal having the wavelength β transferred from the gateway 5a to the second wireless base station 4b that is an output destination corresponding to the wavelength β. The second wireless base station 4b converts the optical signal having the wavelength β dropped by the gateway 5b into an electrical signal and performs predetermined digital processing on the wireless signal from the wireless terminal 2a-2 converted into the electrical signal.

The gateway 5c drops the optical signal having the wavelength γ transferred from the gateway 5a to the second wireless base station 4c that is the output destination corresponding to the wavelength γ. The second wireless base station 4c converts the optical signal having the wavelength γ dropped by the gateway 5c into an electrical signal and performs predetermined digital processing on the wireless signal from the wireless terminal 2a-3 converted into the electrical signal.

Signal transfer in downstream communication in a direction from the second wireless base station 4 to the wireless terminal 2 is opposite to the above-described upstream communication. In other words, the second wireless base station 4a converts a wireless signal addressed to the wireless terminal 2a-1 into an optical signal having a wavelength α according to the wireless section to be used by the wireless terminal 2a-1 or according to the second wireless base station 4a and outputs the converted optical signal to the gateway 5a. The gateway 5a outputs the optical signal having the wavelength α input from the second wireless base station 4a to the optical fiber 6 between the gateway 5a and the first wireless base station 3a that is the output destination according to the wavelength α. The first wireless base station 3a converts an optical signal having the wavelength α into a wireless signal and wirelessly transmits the converted wireless signal to the wireless terminal 2a-1 using a wireless section according to the wavelength α.

The second wireless base station 4b converts a wireless signal addressed to the wireless terminal 2a-2 into an optical signal having a wavelength β according to the wireless section to be used by the wireless terminal 2a-2 or according to the second wireless base station 4b and outputs the converted optical signal to the gateway 5b. The gateway 5b outputs the optical signal having the wavelength β input from the second wireless base station 4b to the optical fiber 6 between the gateway 5b and the gateway 5a that is the output destination according to the wavelength β. The gateway 5a outputs the optical signal having the wavelength β input from the second wireless base station 4b to the optical fiber 6 between the gateway 5a and the first wireless base station 3a that is the output destination according to the wavelength β. The first wireless base station 3a converts an optical signal having the wavelength β into a wireless signal and wirelessly transmits the converted wireless signal to the wireless terminal 2a-2 using a wireless section according to the wavelength β.

The second wireless base station 4c converts a wireless signal addressed to the wireless terminal 2a-3 into an optical signal having a wavelength γ according to a wireless section to be used by the wireless terminal 2a-3 or according to the second wireless base station 4c and outputs the converted optical signal to the gateway 5c. The gateway 5c outputs the optical signal having the wavelength γ received from the second wireless base station 4c to the optical fiber 6 between the gateway 5c and the gateway 5a that is the output destination according to the wavelength γ. The gateway 5a outputs the optical signal having the wavelength γ received from the second wireless base station 4c to the optical fiber 6 between the gateway 5a and the first wireless base station 3a that is the output destination according to the wavelength γ. The first wireless base station 3a converts an optical signal having the wavelength γ into a wireless signal and wirelessly transmits the converted wireless signal to the wireless terminal 2a-3 using a wireless section according to the wavelength γ.

As described above, the analog ROF transmission system converts a wireless signal into an optical signal and transmits the optical signal from the first wireless base station to the second wireless base station via the gateway. The analog RoF transmission system determines a wavelength at the time of transmitting an optical signal through an optical fiber by using an identifier of a wireless section and determines a gateway that the optical signal is transferred to according to the determined wavelength.

Note that different wavelengths may be used for an uplink signal and a downlink signal between the same apparatuses. In a case where the same wavelength is used for an uplink signal and a downlink signal between the same apparatuses, different optical fibers 6 and optical transmission lines 7 may be used between the uplink signal and the downlink signal, or the uplink signal and the downlink signal may be transmitted in a time division manner.

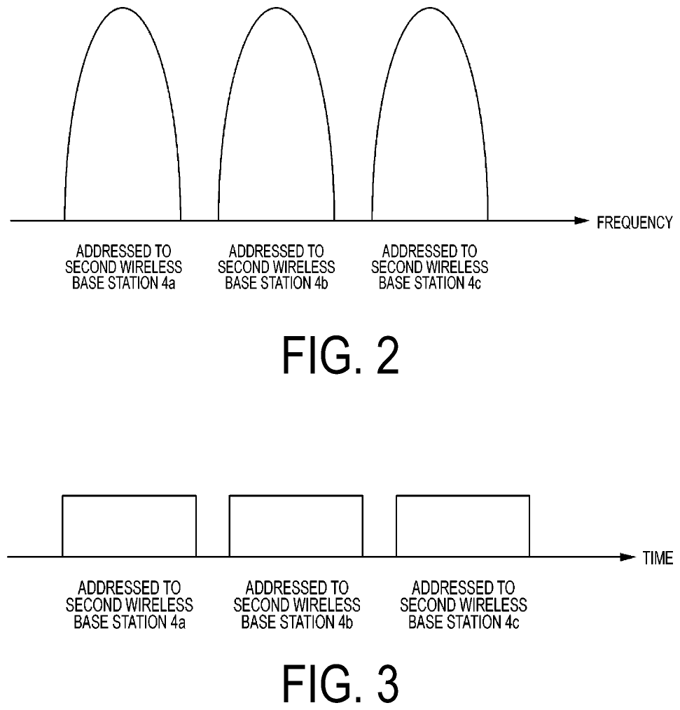

FIGS. 2 and 3 are views illustrating identifiers of wireless sections. FIG. 2 illustrates an example of a case where frequencies of wireless sections are used as the identifiers of the wireless sections. The first wireless base station 3a determines which one of the second wireless base stations 4a, 4b, and 4c is a transmission destination of the wireless signal according to a frequency of the uplink wireless signal received from the wireless terminal 2. The first wireless base station 3a converts the received wireless signal into an optical signal having a wavelength according to the determined transmission destination. In addition, the second wireless base station 4 converts a downstream wireless signal into an optical signal having a wavelength according to a frequency to be used for transmission of the wireless signal.

FIG. 3 illustrates an example of a case where time is used as the identifiers of the wireless sections. The first wireless base station 3a determines which one of the second wireless base stations 4a, 4b, and 4c is a transmission destination of the wireless signal according to the time when the uplink wireless signal received from the wireless terminal 2 is received. The first wireless base station 3a converts the received wireless signal into an optical signal having a wavelength according to the determined transmission destination. As the reception time of the wireless signal, a reception timing such as a slot in which the wireless signal is received may be used. In addition, the second wireless base station 4 converts a downstream wireless signal into an optical signal having a wavelength according to the transmission time of the wireless signal. As the transmission time of the wireless signal, a transmission timing such as a slot in which the wireless signal is to be transmitted may be used.

The identifiers of the wireless sections are not limited to the frequencies or time, and any physical feature may be used as long as the wireless sections can be identified.

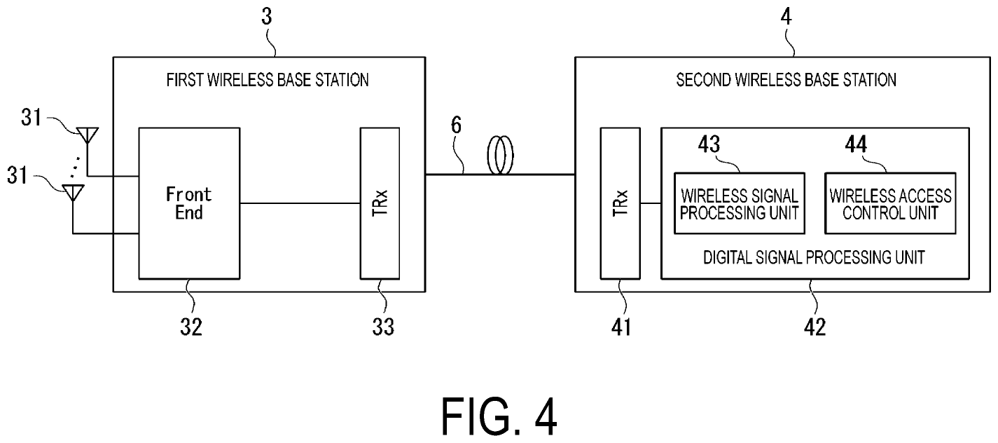

FIG. 4 is a functional block diagram of the first wireless base station 3 and the second wireless base station 4. The first wireless base station 3 and the second wireless base station 4 are connected via the gateway 5 and the optical fiber 6, but the gateway 5 is omitted in FIG. 4.

The first wireless base station 3 includes an antenna 31, a front end 32, and a TRx 33. The antenna 31 transmits and receives a wireless signal to and from the wireless terminal 2. The front end 32 performs processing such as band limitation, frequency conversion, and power amplification on a wireless signal as an electrical signal.

The TRx 33 performs E/O conversion for converting the wireless signal as the electrical signal processed by the front end 32 into an optical signal and outputs the converted optical signal to the optical fiber 6. The TRx 33 converts the wireless signal into an optical signal having a wavelength according to the identifier of the wireless section notified from the front end 32. In addition, the TRx 33 receives a downstream optical signal transmitted through the optical fiber 6 and performs O/E conversion for converting the received optical signal into a wireless signal as an electrical signal. The TRx 33 outputs the converted wireless signal and wavelength information of the optical signal to the front end 32. The front end 32 performs processing such as band limitation, frequency conversion, and power amplification on the wireless signal input from the TRx 33 so as to transmit the wireless signal using a wireless section corresponding to the wavelength of the optical signal and wirelessly transmits the wireless signal from the antenna 31.

The second wireless base station 4 includes a TRx 41 and a digital signal processing unit 42. The TRx 41 performs O/E conversion for converting an upstream optical signal into a wireless signal as an electrical signal and outputs the converted wireless signal to the digital signal processing unit 42. In addition, the TRx 41 performs E/O conversion for converting an electrical signal as a downstream wireless signal into an optical signal and outputs the converted optical signal to the gateway 5.

The digital signal processing unit 42 includes a wireless signal processing unit 43 and a wireless access control unit 44. The wireless signal processing unit 43 modulates and demodulates a wireless signal by digital signal processing. The wireless access control unit 44 performs logical access control, or the like, on a wireless signal by digital signal processing.

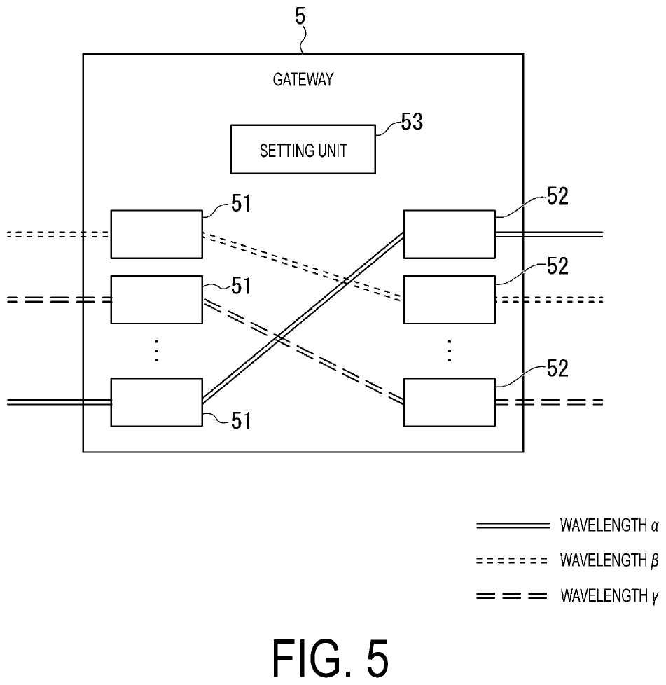

FIG. 5 is a conceptual diagram illustrating functions of the gateway 5. The gateway 5 has a function of changing a transfer destination according to a wavelength. As a method for constituting the gateway 5, for example, it is conceivable to use a Photonic GW as indicated in Reference Literature 1.

Reference Literature 1: Tomoaki Yoshida, “Photonic Gateway and Optical Access Technology Supporting APN”, NTT Technical Journal, February 2021, Internet <URL: https://journal.ntt.co.jp/article/10379>

The gateway 5 includes a plurality of first input/output units 51, a plurality of second input/output units 52, and a setting unit 53. Each of the first input/output units 51 and the second input/output units 52 is connected to the optical fiber 6 or the optical transmission line 7. The plurality of first input/output units 51 may be connected to the same optical fiber 6 or optical transmission line 7, and the plurality of second input/output units 52 may be connected to the same optical fiber 6 or optical transmission line 7. In this case, a wavelength multiplexer/demultiplexer may be provided between the optical fiber 6 or the optical transmission line 7 and the plurality of first input/output units 51 or the plurality of second input/output units 52.

The gateway 5, in accordance with the set transfer path, outputs an optical signal input from the first input/output unit 51 from any of the second input/output units 52 according to the wavelength of the optical signal and outputs an optical signal input from the second input/output unit 52 from any of the first input/output units 51 according to the wavelength of the optical signal. The setting unit 53 sets connection between the first input/output unit 51 and the second input/output unit 52 and a wavelength of an optical signal to be used for the connection in the first input/output unit and the second input/output unit 52. The setting unit 53 can change the transfer destination of the optical signal according to the wavelength by changing this setting. Note that the setting unit 53 may be provided in another device connected to the gateway 5.

Processing in a case where the wireless terminal 2a-2 illustrated in FIG. 1 transmits and receives a wireless signal will be described with reference to the configurations of FIGS. 4 and 5.

The front end 32 of the first wireless base station 3a performs processing such as band limitation, frequency conversion, and power amplification on the upstream wireless signal from the wireless terminal 2a-2 received by the antenna 31. The front end 32 outputs the processed wireless signal and information of the identifier of the wireless section of the wireless signal to the TRx 33. The TRx 33 converts the electrical signal input from the front end 32 into an optical signal having the wavelength β according to the identifier of the wireless section. The TRx 33 outputs the converted optical signal to the optical fiber 6. Alternatively, instead of outputting the information of the identifier of the wireless section, the front end 32 may instruct the TRx 33 to perform conversion into the wavelength β corresponding to the identifier of the wireless section. Alternatively, the front end 32 may select the second wireless base station 4b corresponding to the identifier of the wireless section and instruct the TRx 33 to perform conversion into the wavelength β corresponding to the selected second wireless base station 4b.

The first input/output unit 51 of the gateway 5a inputs the optical signal from the first wireless base station 3a transmitted through the optical fiber 6. The first input/output unit 51 outputs the input optical signal to the second input/output unit 52 according to the wavelength β. The second input/output unit 52 outputs the optical signal input from the first input/output unit 51 to the optical fiber 6 between the gateway 5a and the gateway 5b.

The first input/output unit 51 of the gateway 5b inputs the optical signal from the gateway 5a transmitted through the optical fiber 6. The first input/output unit 51 outputs the input optical signal to the second input/output unit 52 according to the wavelength β. The second input/output unit 52 drops the optical signal input from the first input/output unit 51 to the second wireless base station 4b. The TRx 41 of the second wireless base station 4b converts the optical signal dropped by the gateway 5b into a wireless signal as an electrical signal. The wireless signal processing unit 43 demodulates the wireless signal.

In addition, the wireless signal processing unit 43 of the second wireless base station 4b generates a downstream wireless signal addressed to the wireless terminal 2a-2. The wireless signal processing unit 43 acquires the identifier of the wireless section of the wireless terminal 2a-2 from the wireless access control unit 44 and outputs the generated wireless signal and the identifier of the wireless section to the TRx 41. The TRx 41 converts the wireless signal input from the wireless signal processing unit 43 from the electrical signal into the optical signal having the wavelength β in accordance with the identifier of the wireless section. Alternatively, instead of outputting the identifier of the wireless section, the wireless signal processing unit 43 may instruct the TRx 33 to perform conversion into the wavelength β corresponding to the identifier of the wireless section. Alternatively, the TRx 41 may convert the wireless signal into an optical signal having the wavelength β corresponding to the TRx 41. The TRx 41 outputs the converted optical signal to the gateway 5b.

The second input/output unit 52 of the gateway 5b inputs the optical signal from the second wireless base station 4a. The second input/output unit 52 outputs the input optical signal to the first input/output unit 51 according to the wavelength β. The first input/output unit 51 outputs the optical signal input from the second input/output unit 52 to the optical fiber 6 between the gateway 5b and the gateway 5a.

The second input/output unit 52 of the gateway 5a inputs the optical signal from the gateway 5b transmitted through the optical fiber 6. The second input/output unit 52 outputs the input optical signal to the first input/output unit 51 according to the wavelength β. The first input/output unit 51 outputs the optical signal input from the second input/output unit 52 to the optical fiber 6 between the gateway 5a and the first wireless base station 3a.

The TRx 33 of the first wireless base station 3a converts the optical signal from the gateway 5a transmitted through the optical fiber 6 into a wireless signal as an electrical signal. The TRx 33 outputs the converted wireless signal and information of the wavelength β of the optical signal to the front end 32. The front end 32 performs processing such as band limitation, frequency conversion, and power amplification on the wireless signal input from the TRx 33 so as to use a wireless section corresponding to the wavelength β and wirelessly transmits the wireless signal from the antenna 31. The wireless terminal 2a-2 receives the wireless signal.

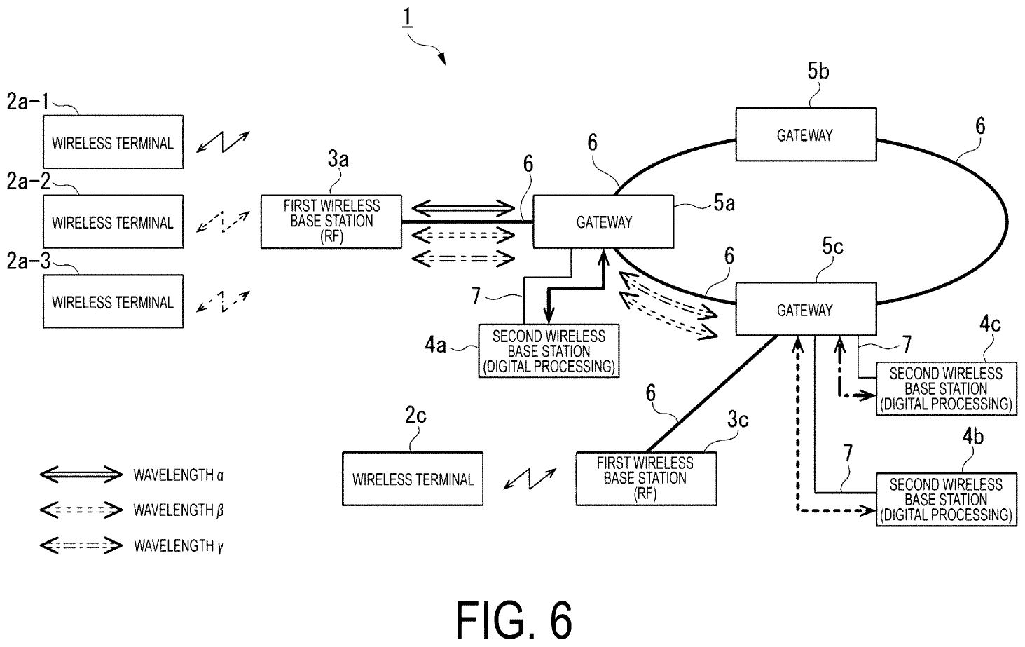

FIG. 6 is a view illustrating signal transfer in the transmission system 1 after the setting is changed. In FIG. 6, a network connection configuration is changed so that a connection destination of the second wireless base station 4b is changed from the gateway 5b to the gateway 5c. In this case, the setting unit 53 of the gateway 5a performs setting such that the connection destination of the first input/output unit 51 that inputs and outputs the optical signal having the wavelength β to and from the optical fiber 6 between the gateway 5a and the first wireless base station 3a is changed from the second input/output unit 52 that inputs and outputs the optical signal having the wavelength β to and from the optical fiber 6 between the gateway 5a and the gateway 5b to the second input/output unit 52 that inputs and outputs the wavelength β to and from the optical fiber 6 between the gateway 5a and the gateway 5c. In addition, the setting unit 53 of the gateway 5c changes the setting so as to connect the first input/output unit 51 that inputs and outputs the optical signal having the wavelength β to and from the optical fiber 6 between the gateway 5c and the gateway 5b to the second input/output unit 52 that inputs and outputs the optical signal having the wavelength β to and from the optical transmission line 7 between the gateway 5c and the second wireless base station 4b.

As described above, the setting unit 53 of each gateway 5 sets correspondence between the wavelength of the optical signal and the transfer destination in the gateway 5 so that the gateway 5 that drops the optical signal having the wavelength corresponding to the wireless section to be processed by the second wireless base station 4 can be selected.

The first wireless base station 3a operates similarly to the case of FIG. 1, converts an uplink wireless signal received from the wireless terminal 2a-2 into an optical signal having the wavelength β and transmits the optical signal to the gateway 5a. The first input/output unit 51 of the gateway 5a outputs the optical signal input from the first wireless base station 3a from the second input/output unit 52 according to the wavelength β to the gateway 5c. The first input/output unit 51 of the gateway 5c drops the optical signal input from the gateway 5a from the second input/output unit 52 corresponding to the wavelength β to the second wireless base station 4b.

The second wireless base station 4b converts the optical signal having the wavelength β dropped by the gateway 5c into an electrical signal and demodulates the wireless signal from the wireless terminal 2a-2 converted into the electrical signal.

The second wireless base station 4b converts a downlink wireless signal addressed to the wireless terminal 2a-2 into an optical signal having the wavelength β and outputs the converted optical signal to the gateway 5c. The second input/output unit 52 of the gateway 5c outputs the optical signal input from the second wireless base station 4b from the first input/output unit 51 according to the wavelength β to the gateway 5a. The second input/output unit 52 of the gateway 5a transfers the optical signal having the wavelength β input from the gateway 5c from the first input/output unit 51 according to the wavelength β to the first wireless base station 3a. The first wireless base station 3a converts the optical signal having the wavelength β into a wireless signal and transmits the converted wireless signal to the wireless terminal 2a-2 in the wireless section according to the wavelength β, similarly to before the network connection configuration is changed.

As described above, the transmission system 1 of the present embodiment can select the gateway 5 that demultiplexes an optical signal to the second wireless base station that converts the optical signal into an electrical signal in order to modulate/demodulate the digital signal on the basis of the identifier of the wireless section. In addition, the gateway 5 that drops the wireless signal to be transmitted and received by the wireless terminal 2a-2 can be changed without being affected by transfer of the wireless signal to be transmitted and received by the wireless terminals 2a-1 and 2a-3.

According to the communication system of the above-described embodiment, it is possible to construct a network physically segmented by a wireless section and a wired section. Thus, the communication system of the present embodiment can reduce a processing delay and improve security as compared with a case where a network is logically segmented.

According to the embodiment described above, the transmission system includes one or more first communication apparatuses that transmit and receive a wireless signal to and from the wireless terminal apparatus, one or more second communication apparatuses that transmit and receive an optical signal to and from the first communication apparatus, and one or more transfer apparatuses that transfer an optical signal between the first communication apparatus and the second communication apparatus. For example, the first communication apparatus corresponds to the first wireless base station 3 of the embodiment, the second communication apparatus corresponds to the second wireless base station 4 of the embodiment, and the transfer apparatus corresponds to the gateway 5 of the embodiment. The first communication apparatus converts a wireless signal to be transmitted and received to and from the wireless terminal apparatus and an optical signal having a wavelength corresponding to a physical feature amount of a wireless section to be transmitted by the wireless signal. The transfer apparatus receives an optical signal between the first communication apparatus and the second communication apparatus and transfers the received optical signal to the first communication apparatus, the second communication apparatus, or another transfer apparatus that is a transfer destination according to a wavelength of the optical signal. The second communication apparatus transmits and receives to and from the first communication apparatus, an optical signal transferred by the one or more transfer apparatuses and having the wavelength corresponding to a wireless section to be processed by an own apparatus.

The transmission system may include a setting unit that sets correspondence between a wavelength and a transfer destination in the transfer apparatus such that the transfer apparatus that drops the optical signal having the wavelength corresponding to the wireless section to be processed by the second communication apparatus can be selected. In addition, the physical feature amount of the wireless section may be a frequency of a wireless signal or a timing of reception or transmission of the wireless signal.

Although the embodiment of the present invention has been described in detail with reference to the drawings so far, specific configurations are not limited to the embodiment, and include designs, and the like, without departing from the gist of the invention.

### Reference Signs List

1 Transmission system
2a-1 to 2a-3, 2c Wireless terminal
3, 3a, 3c First wireless base station
4, 4a, 4b, 4c Second wireless base station
5, 5a, 5b, 5c Gateway
6 Optical fiber
7 Optical transmission line
31 Antenna
32 Front end
33 TRx
41 TRx
42 Digital signal processing unit
43 Wireless signal processing unit
44 Wireless access control unit
51 First input/output unit
52 Second input/output unit
53 Setting unit

1. A transmission system comprising:
a first communication apparatus that receives a first wireless signal from a wireless terminal apparatus and transmits a second wireless signal to the wireless terminal apparatus;
a second communication apparatus that receives a first optical signal from the first communication apparatus and transmits a second optical signal to the first communication apparatus; and
a transfer apparatus that transfers the first optical signal and the second optical signal between the first communication apparatus and the second communication apparatus, wherein:
the first communication apparatus (i) converts the first wireless signal which has been received from the wireless terminal apparatus into the first optical signal having a first wavelength corresponding to a first physical feature amount of a first wireless section through which the first wireless signal has been transmitted and (ii) converts the second optical signal into the second wireless signal to be transmitted to the wireless terminal apparatus through the second wireless section which has a second physical feature amount corresponding to a second wavelength of the second optical signal;
the transfer apparatus (i) receives the first optical signal and the second optical signal, (ii) transfers the received first optical signal to the second communication apparatus, or another transfer apparatus as a transfer destination depending on the first wavelength of the first optical signal, and (iii) transfers the received second optical signal to the first communication apparatus or the another transfer apparatus depending on the second wavelength of the second optical signal; and
the second communication apparatus (i) receives, from the first communication apparatus, the first optical signal transferred by the transfer apparatus and having the first wavelength corresponding to the first wireless section to be processed by the second communication apparatus and (ii) transmits, to the first communication apparatus, the second optical signal to be transferred by the transfer apparatus and having the second wavelength corresponding to the second wireless section to be processed by the second communication apparatus.

2. The transmission system according to claim 1, comprising:
a setting circuitry that sets correspondence between the first wavelength or the second wavelength and a transfer destination in the transfer apparatus such that the transfer apparatus that drops the optical signal having the first wavelength corresponding to the first wireless section to be processed by the second communication apparatus can be selected.

3. The transmission system according to claim 1, wherein
the first physical feature amount is a frequency of the first wireless signal and the second physical feature amount is a frequency of the second wireless signal.

4. The transmission system according to claim 1, wherein
the first physical feature amount is a timing of reception of the first wireless signal and the second physical feature amount is a timing of transmission of the second wireless signal.

5. A transmission method in a transmission system which includes:
a first communication apparatus that receives a first wireless signal from a wireless terminal apparatus and transmits a second wireless signal to the wireless terminal apparatus;
a second communication apparatus that receives a first optical signal from the first communication apparatus and transmits a second optical signal to the first communication apparatus; and
a transfer apparatus that transfers the first optical signal and the second optical signal between the first communication apparatus and the second communication apparatus,
the transmission method comprising:
converting, by the first communication apparatus, the first wireless signal which has been received from the wireless terminal apparatus into the first optical signal having a first wavelength corresponding to a first physical feature amount of a first wireless section through which the first wireless signal has been transmitted and converting, by the first communication apparatus, the second optical signal into the second wireless signal to be transmitted to the wireless terminal apparatus through the second wireless section which has a second physical feature amount corresponding to a second wavelength of the second optical signal;
by the transfer apparatus, (i) receiving the first optical signal and the second optical signal, (ii) transferring the received first optical signal to the second communication apparatus, or another transfer apparatus as a transfer destination depending on the first wavelength of the first optical signal, and (iii) transferring the received second optical signal to the first communication apparatus or the another transfer apparatus depending on the second wavelength of the second optical signal; and
receiving from the first communication apparatus, by the second communication apparatus, the first optical signal transferred by the transfer apparatus and having the first wavelength corresponding to the first wireless section to be processed by the second communication apparatus and transmitting, to the first communication apparatus, the second optical signal to be transferred by the transfer apparatus and having the second wavelength corresponding to the second wireless section to be processed by the second communication apparatus.
